(19) United States
(12) Patent Application Publication
(10) Pub. No.: US 2011/0298808 A1
(43) Pub. Date: Dec. 8, 2011

(54) Animated Vehicle Attendance Systems

(75) Inventor: Christopher Lee Rovik, Canton, MI (US)

(73) Assignee: Toyota Motor Engineering & Manufacturing North America, Inc., Erlanger, KY (US)

(21) Appl. No.: 12/792,094

(22) Filed: Jun. 2, 2010

(51) Int. Cl. G06T 15/70

(52) U.S. Cl. 345/473

(57) ABSTRACT

In one embodiment, an animated vehicle attendant system may include: a communication path positioned within a vehicle; an avatar creation interface positioned within a passenger compartment of the vehicle and communicatively coupled to the communication path; a first display positioned within the passenger compartment of the vehicle and communicatively coupled to the communication path, wherein the first display includes a first processor and a first memory; a second display positioned within the passenger compartment of the vehicle and communicatively coupled to the communication path, wherein the second display includes a second processor and a second memory; and an animated avatar including one or more alterable visual characteristics. The animated avatar is stored in the first memory and/or the second memory. The first processor and/or the second processor executes machine readable instructions to: receive input from the avatar creation interface; update the one or more alterable visual characteristics based upon the input from the avatar creation interface; and present the animated avatar on the first display and/or the second display.

### TECHNICAL FIELD

The present specification generally relates to systems for information exchange and, more specifically, systems for providing a pseudo-relationship between a driver and an animated avatar linked to various vehicle systems.

### BACKGROUND

Vehicles are complex systems that may contain an assortment of instruments and displays that communicate necessary or useful information to a driver. For example, an instrument cluster may illuminate a light to indicate that service is needed or a global positioning system display screen can provide turn by turn directions. However, such communications are generic and austere. Thus, a driver may find it difficult to develop a personal attachment to the vehicle. A failure to develop a personal attachment to the vehicle may lead a driver to distrust or ignore information that the vehicle displays attempt to communicate to the driver.

Accordingly, a need exists for alternative systems for providing a pseudo-relationship between a driver and an animated avatar linked to various vehicle systems.

### SUMMARY

In one embodiment, an animated vehicle attendant system may include: a communication path positioned within a vehicle; an avatar creation interface positioned within a passenger compartment of the vehicle and communicatively coupled to the communication path; a first display positioned within the passenger compartment of the vehicle and communicatively coupled to the communication path, wherein the first display includes a first processor and a first memory; a second display positioned within the passenger compartment of the vehicle and communicatively coupled to the communication path, wherein the second display includes a second processor and a second memory; and an animated avatar including one or more alterable visual characteristics. The animated avatar is stored in the first memory and/or the second memory. The first processor and/or the second processor executes machine readable instructions to: receive input from the avatar creation interface; update the one or more alterable visual characteristics based upon the input from the avatar creation interface; and present the animated avatar on the first display and/or the second display.

In another embodiment, an animated vehicle attendant system may include: a communication path positioned within a vehicle; an environmental sensor coupled to the vehicle and communicatively coupled to the communication path, wherein the environmental sensor includes an environmental memory for storing environmental information; a display positioned within a passenger compartment of the vehicle and communicatively coupled to the communication path, wherein the display includes a processor and a memory; an avatar creation interface positioned within the passenger compartment of the vehicle and communicatively coupled to the communication path; and an animated avatar including one or more alterable visual characteristics. The animated avatar is stored in the memory. The processor executes machine readable instructions to: receive the environmental information from the environmental memory; receive input from the avatar creation interface; update the one or more alterable visual characteristics based upon the environmental information; update the one or more alterable visual characteristics of the animated avatar based upon the input from the avatar creation interface; and present an updated animated avatar on the display.

In yet another embodiment, an animated vehicle attendant system may include: a communication path positioned within a vehicle; an avatar creation interface positioned within a passenger compartment of the vehicle and communicatively coupled to the communication path; a display positioned within the passenger compartment of the vehicle and communicatively coupled to the communication path, wherein the display includes a processor and a memory; and an animated avatar including an aging rate. The animated avatar is stored in the memory. The processor executes machine readable instructions to: receive input from the avatar creation interface; update the aging rate based upon the input from the avatar creation interface; and present the animated avatar on the display.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an animated vehicle attendant system according to one or more embodiments shown and described herein;

FIG. 2A schematically depicts selectable components of an animated avatar according to one or more embodiments shown and described herein;

FIG. 2B schematically depicts functional aspects of an animated avatar according to one or more embodiments shown and described herein;

FIG. 3 schematically depicts an animated vehicle attendant system according to one or more embodiments shown and described herein;

FIG. 4A schematically depicts an animated vehicle attendant system according to one or more embodiments shown and described herein;

FIG. 4B schematically depicts an animated vehicle attendant system according to one or more embodiments shown and described herein; and

FIG. 5 graphically depicts a time based evolution of an animated avatar according to one or more embodiments shown and described herein.

### DETAILED DESCRIPTION

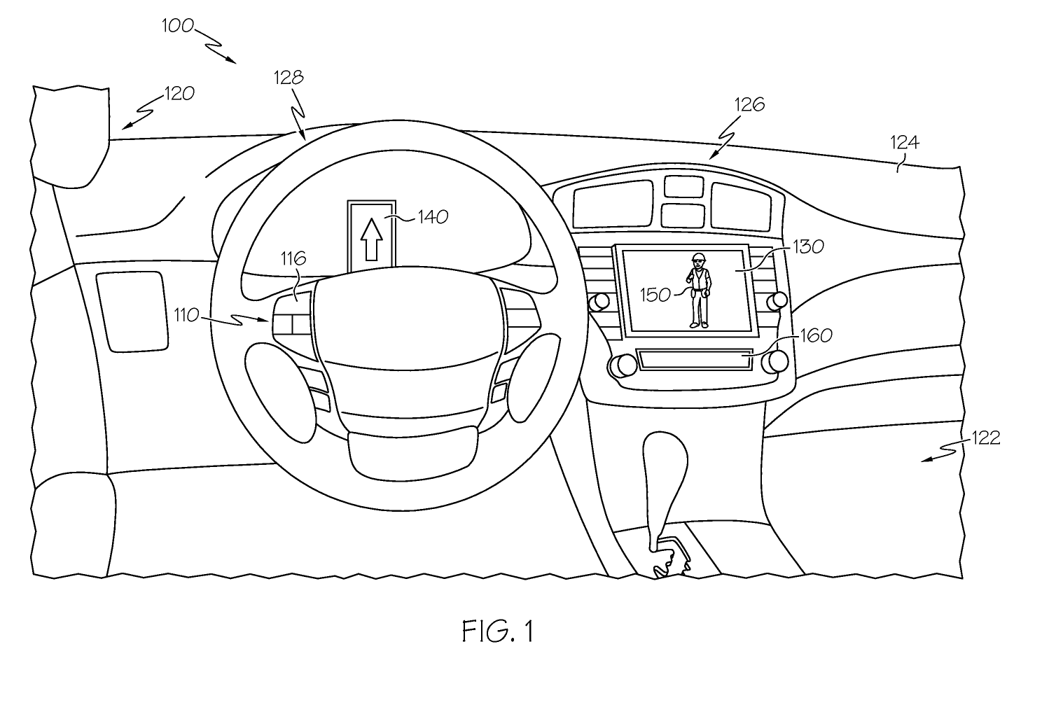

FIG. 1 generally depicts one embodiment of an animated vehicle attendant system. The animated vehicle attendant system generally comprises an avatar creation interface, an animated avatar stored in memory and comprising one or more alterable visual characteristics, and one or more displays for presenting the animated avatar. Various embodiments of the animated vehicle attendant system and the operation of the animated vehicle attendant system will be described in more detail herein.

Referring now to FIG. 1, an embodiment of a vehicle 120 with an animated vehicle attendant system 100 is depicted. The animated vehicle attendant system 100 generally comprises an avatar creation interface 110, an animated avatar 150 with one or more alterable visual characteristics 152 stored in memory and displayable on one or more displays 130, 140, 160 positioned within the passenger compartment 122 and comprising a processor and a memory.

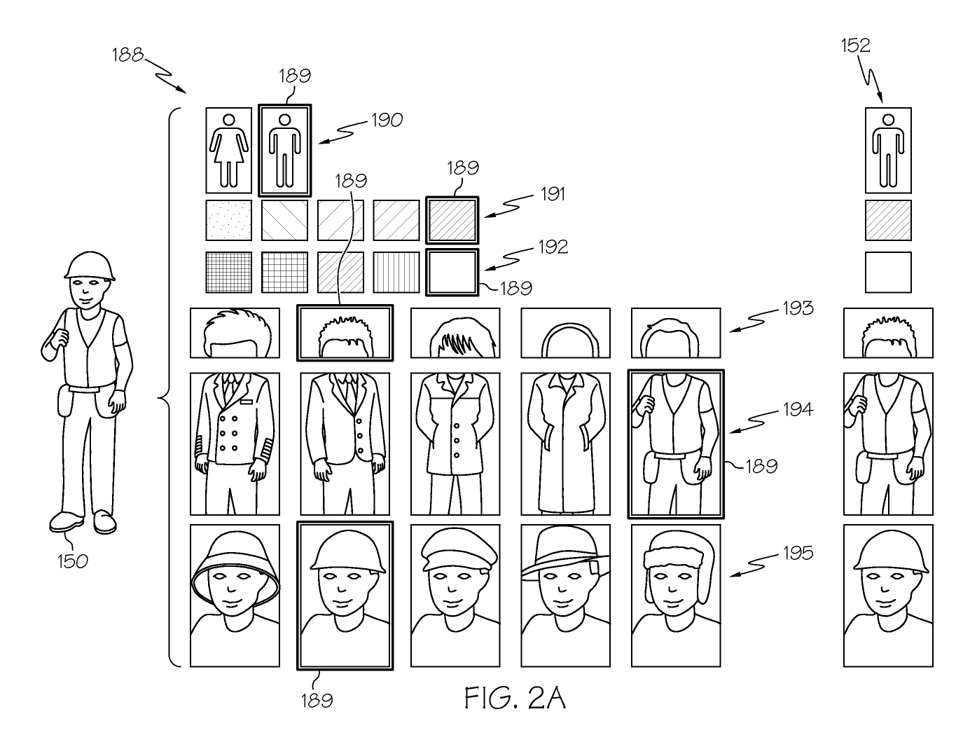

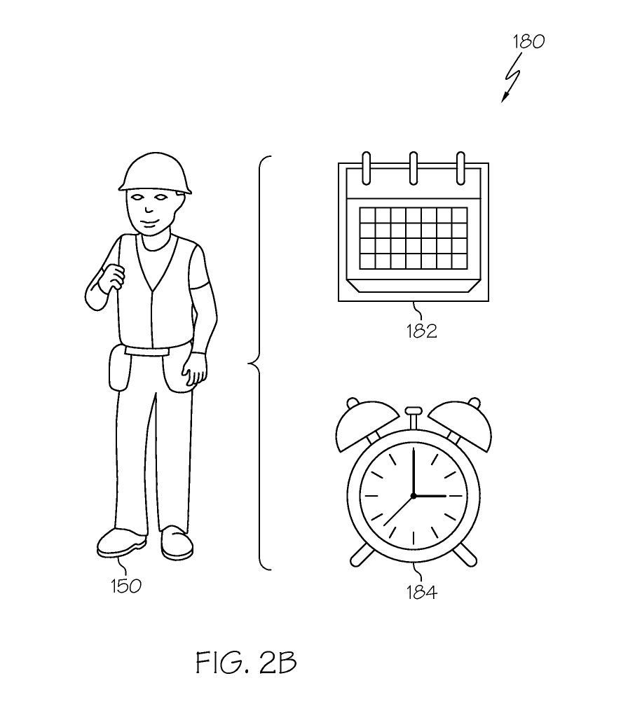

Referring now to FIG. 2A, the animated avatar 150 may be used to establish a pseudo-relationship with the driver. Specifically, the animated avatar 150 comprises one or more alterable visual characteristics 152. In one embodiment, the animated avatar 150 appears as a composite of the one or more alterable visual characteristics 152 stored in a memory operably associated with the system that is presented to the driver. For example, the animated avatar 150 appears like a male construction worker. The construction worker is a composite combination of selected options 189 of a gender submenu 190, a skin tone submenu 191, a hair color submenu 192, a hair style submenu 193, clothing submenu 194 and a hat submenu 195. While a limited set of the one or more alterable visual characteristics 152 are described hereinabove, the one or more alterable visual characteristics 152 may be any feature that alters the appearance of the animated avatar 150 such as, for example, age, size, weight, ethnicity, backgrounds, tools, sports equipment, jewelry, pets, bags, purses, accessories, and any other customizable feature.

Referring now to FIG. 2B in one embodiment, the animated avatar 150 may also comprise one or more alterable functional characteristics 180 to customize the functionality of the animated avatar 150 to suit the needs of the driver. For example, in one embodiment the one or more alterable functional characteristics 180 comprise a calendar function 182 (represented by a calendar icon) and a frequency function 184 (represented by a clock icon). In one embodiment, the calendar function 182 stores important date related information in a memory operably associated with the system. Any date may be stored in a memory, such as, for example, service dates, end of lease dates, birthdays and the like. The animated avatar 150 may use the dates stored in the memory as a reference for some action such as, for example, audibly reminding the driver to refuel, appearing with a wrench to remind the driver of an oil change or appearing with a cake on the driver's birthday. In further embodiments, the one or more alterable functional characteristics 180 comprise a frequency function 184 that establishes how often the animated avatar 150 appears within a display. The frequency function 184 may set the repetitiveness of appearances of the animated avatar 150. The repetitiveness may be set to any value from no appearances through a constant appearance. For example, repetitiveness may be set to high if the driver wishes to interact continuously, medium for daily interaction, or low for interaction during alert events only. Alert events may be, for example, service requirements based on vehicle condition, date based reminders, weather warnings, directions from a navigation system, and alerts from an audio transmitter or any other module communicatively coupled with the vehicle.

Referring again to FIG. 1, in one embodiment the avatar creation interface 110 is a control or controls positioned within the vehicle 120 that serves as an interconnection between a driver and the animated avatar 150. In one embodiment, the avatar creation interface 110 is a collection of buttons and knobs (alternative embodiments may comprise a touch screen) positioned on a steering wheel that a driver may use to input information to the animated avatar 150. The physical motion of the buttons and knobs are digitized into electric signals, which are transmitted to a processor and a memory. The electric signals interact with the animated avatar 150 to alter the appearance or functionality of the animated avatar 150 stored in memory. Thus, the driver may interact with and adjust the animated avatar 150 through the avatar creation interface 110. In further embodiments, the avatar creation interface 110 may be any type of control positioned within the vehicle 120, such as, for example touch screens, voice recognition systems, image recognition systems, a control located on the console and any other control module integral with the vehicle 120. Furthermore, it is noted that embodiments of the present disclosure may comprise more than one avatar creation interface 110, configured to interact with the animated avatar 150. The multiple avatar creation interfaces may be configured to interact with the animated avatar 150 simultaneously.

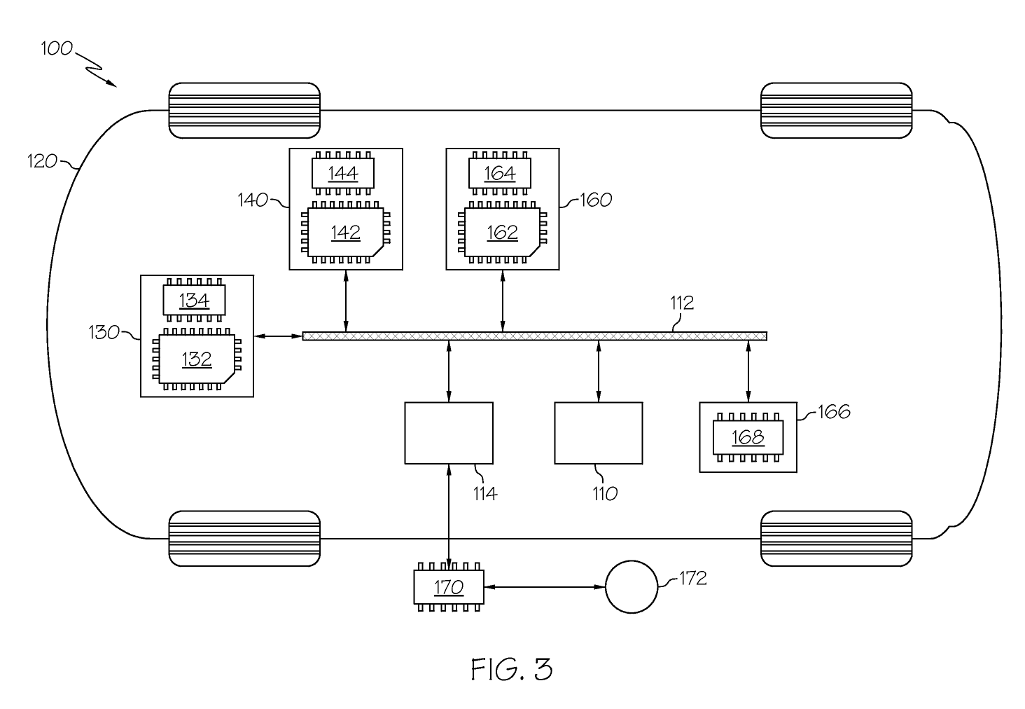

Referring now to FIG. 3, the one or more displays 130, 140, 160 are screens positioned within the vehicle 120 that graphically present data. Each display comprises a processor for executing machine readable instructions and a memory for electronically storing machine readable instructions and machine readable information. The processor may be an electronic control unit, an integrated circuit, a microchip, a computer or any other computing device capable of executing machine readable instructions. The memory may be RAM, ROM, a flash memory, a hard drive, or any device capable of storing machine readable instructions. In the embodiments described herein, the processor and the memory are integral with the display. However, it is noted that the display, the processor, and the memory may be discrete components communicatively coupled to one another such as, for example, modules on a communication path 112 without departing from the scope of the present disclosure. Furthermore, it is noted that the phrase “communicatively coupled,” as used herein, means that components are capable of transmitting data signals with one another such as, for example, electrical signals via a conductive medium, electromagnetic signals via air, optical signals via optical waveguides, and the like.

Still referring to FIG. 3, the embodiments of the system described herein may comprise one or more displays 130, 140, 160 for graphically presenting the animated avatar 150 (FIG. 1). For example, the one or more displays comprise an audio head unit display 130, an instrument cluster display 140, a climate display 160, or combinations thereof. The audio head unit display 130 is communicatively coupled with the communication path 112 and comprises audio processor 132 and an audio memory 134. The instrument cluster display 140 is communicatively coupled with the communication path 112 and comprises a cluster processor 142 and a cluster memory 144. The climate display 160 is communicatively coupled with the communication path 112 and comprises a climate processor 162 and a climate memory 164. In the embodiments described herein, each of the displays described hereinabove operates as a separate module on the communication path 112.

The communication path 112 depicted in FIG. 3 is a data exchange medium positioned within the vehicle 120 that provides data interconnectivity between various vehicle modules. The communication path 112 comprises a conductive material that permits the transmission of electrical data signals to processors, sensors, and actuators throughout the vehicle 120. Each of the modules operates as a node that may send and receive messages. In one embodiment, the communication path 112 is a vehicle bus, such as for example a LIN bus, a CAN bus, a VAN bus, and the like. In further embodiments, the communication path 112 may be wireless or, alternatively, an optical waveguide.

Further embodiments of the vehicle attendant system 100 comprise a vehicle-machine communication device 114, an environmental sensor 166, a remote memory 170, and a vehicle attendant portal 172. Each of which will be described in more detail herein. The vehicle-machine communication device 114, as depicted in FIG. 3, provides a data exchange mechanism between the vehicle 120 and external systems. In one embodiment, the vehicle-machine communication device 114 is a radio communication module on the communication path 112 that provides a two-way data exchange with a cellular network. For example, the radio communication module may receive data from a cellular network that provides an update for the appearance of the animated avatar 150. Alternatively, the radio communication module may transmit data indicative of the appearance of the animated avatar 150 to a cellular device via the cellular network. In further embodiments, the vehicle-machine communication device 114 may be a global positioning system device, microwave device, an infrared device, a wireless internet network device, a universal serial bus device, or any other device suitable for exchanging data.

The environmental sensor 166 is a device sensitive to ambient conditions outside of the vehicle 120 that transmits a signal indicative of the ambient condition to a module on the communication path 112. The environmental sensor 166 comprises an environmental memory 168 that stores information indicative of a sensed ambient condition. For example, the environmental sensor may sense temperature information outside of the vehicle 120. The temperature information is stored in the environmental memory 168 for transmission to another module on the communication path 112. Embodiments of the environmental sensor 166 may measure ambient conditions such as, for example, light, temperature, barometric pressure, altitude, humidity, precipitation and the like.

The remote memory 170 is a supplemental memory device that is separate from the vehicle 120. In embodiments of the present disclosure, the remote memory 170 is communicatively coupled to the vehicle-machine communication device 114. For example, the remote memory may be a universal serial bus memory (e.g., flash drive) that comprises machine readable information. The flash drive is communicatively coupled to a universal serial bus socket of the vehicle-machine communication device 114, and the machine readable information may be delivered to other modules on the communication path 112. Alternatively, the remote memory 170 may be any type of memory described hereinabove, in addition to a memory device connected to an internet device, such as, for example, a server or a computer.

The vehicle attendant portal 172 is a computer interface that provides access to and control of information from diverse sources. In one embodiment, the vehicle attendant portal 172 resides on an internet server and is available via the World Wide Web. In another embodiment, the vehicle attendant portal 172 is communicatively coupled to the remote memory 170. Therefore, information organized by the vehicle attendant portal 172 may be stored on the remote memory 170. For example, a driver may access a web site by connecting to the internet through an internet capable device, such as, for example, a personal computer. The web site provides access to multiple applications and databases, which modify information stored on the remote memory 170. In alternative embodiments, the vehicle attendant portal 172 resides on a local computer that is communicatively coupled to a flash drive or portable hard drive.

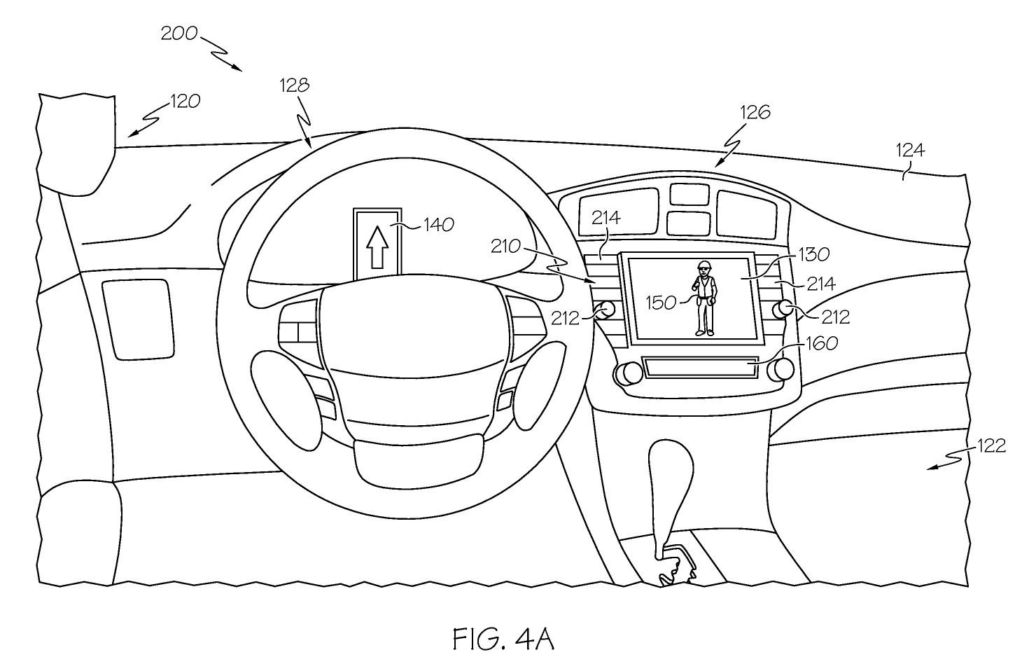

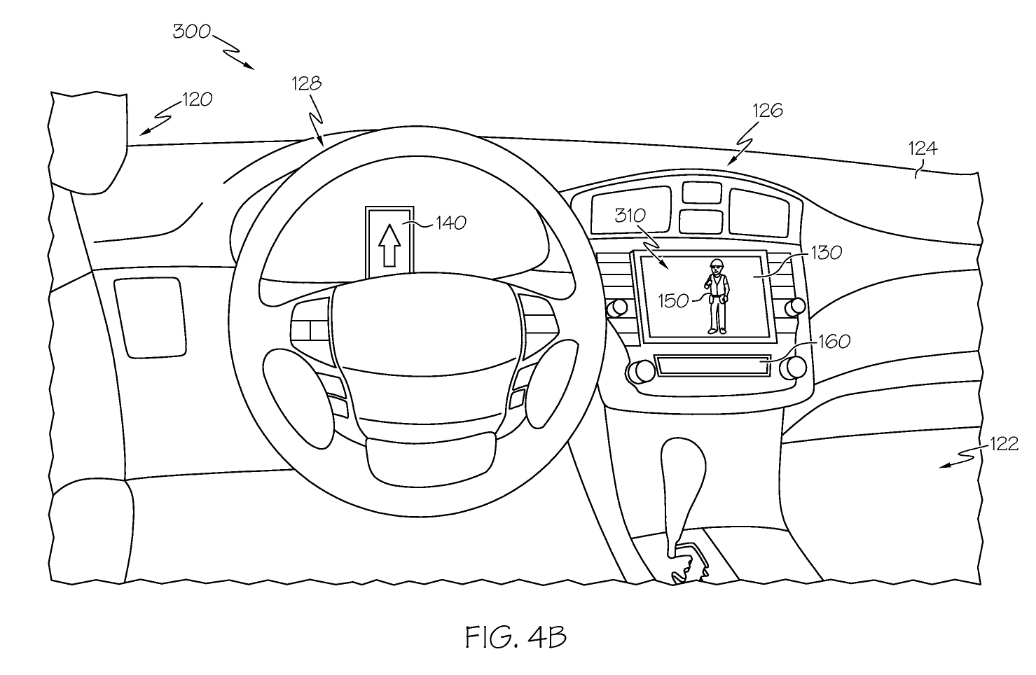

Referring now to FIGS. 1, 4A and 4B, embodiments of the animated vehicle attendant system 100, 200, and 300, may be located in a passenger compartment 122 of a vehicle 120. The passenger compartment 122 comprises an instrument panel 124 having a central portion 126 and a driver-side portion 128. The instrument panel 124 spans the passenger compartment 122, and the central portion 126 is positioned in the center region of the instrument panel 124 and the driver-side portion 128 is positioned in the region of the instrument panel 124 in front of a driver operating the vehicle 120. The central portion 126 and the driver-side portion are delineated by a section of the instrument panel 124 directly behind the steering wheel, i.e. the section is within the driver-side portion 128 and defines the outer bounds of the driver-side portion 128.

The instrument panel 124 comprises one or more displays 130, 140, and 160 on which an animated avatar 150 may be presented. In one embodiment, the audio head unit display 130 is positioned within the central portion 126 of the instrument panel 124. In another embodiment, the instrument cluster display 140 is positioned within the driver-side portion 128 of the instrument panel 124. In a further embodiment, a climate display 160 is positioned within the central portion 126 of the instrument panel 124. In embodiments of the present disclosure, each of the displays described hereinabove operate as modules on the communication path 112. Embodiments of the animated vehicle attendant system 100, 200, and 300 comprise an avatar creation interface 110, 210 and 310 for providing an interconnection between a driver and the animated avatar 150.

Referring now to FIGS. 1 and 3, in one embodiment of the animated vehicle attendant system 100, the avatar creation interface 110 is positioned on the steering wheel. The avatar creation interface 110 may be a collection of buttons 116 integrated with the steering wheel that provide input into the definition of the animated avatar 150 stored in the audio memory 134. For example, animated avatar 150 may comprise one or more alterable visual characteristics 152 and one or more alterable functional characteristics 180. The audio processor 132 executes machine readable instructions to receive input from the avatar creation interface 110, and transmit the input to the audio memory 134. The input from the avatar creation interface 110 updates the one or more alterable visual characteristics 152 and/or the one or more alterable functional characteristics 180 stored in the audio memory 134. The updated animated avatar 150 is presented on the audio head unit display 130 according to the one or more alterable visual characteristics 152 and/or the one or more alterable functional characteristics 180 stored in the audio memory 134. Additional detail regarding the input process by which the avatar is updated will be provided below.

Referring now to FIGS. 2A and 4A, the animated vehicle attendant system 200 may comprise an avatar creation interface 210 positioned in the central portion 126 of the instrument panel 124. For example, the avatar creation interface 210 may be an array of dials 212 and buttons 214 adjacent to the audio head unit display 130. A visual characteristic menu 188 presents options that can be set as the one or more alterable visual characteristics 152 on the audio head unit display 130. The visual characteristic menu 188 may be activated by pressing a button 214 and may be navigated by rotating a dial 212. The driver selects selected options 189 by pressing a button 214. The selected options 189 are stored in the audio memory 134 thus updating the one or more alterable visual characteristics 152 of the avatar. In this example, a construction worker appearance results from the following selected options 189: male from a gender submenu 190, light complexion from a skin tone submenu 191, blond from a hair color submenu 192, crew cut from a hair style submenu 193, working outfit from a clothing submenu 194 and hard hat from a hat submenu 195. As a result of input from the avatar creation interface 210, a composite character is constructed from a combination of selected options 189 from the visual characteristic menu 188 and graphically presented as the animated avatar 150 on a display.

Referring now to FIGS. 2B and 4B, the animated vehicle attendant system 300 may comprise an avatar creation interface 310 that is a touch screen integrated with the audio head unit display 130. In one embodiment, the avatar creation interface 310 may be used to set the one or more alterable functional characteristics 180 stored in memory. For example, a calendar function 182 (represented by a calendar icon) and a frequency function 184 (represented by a clock icon) may be displayed on the audio head unit display 130. A driver can alter the calendar function 182 by touching an icon and entering dates by touching alphanumeric icons presented on the touch screen. The dates are stored in memory as components of the one or more alterable functional characteristics 180. In another example, the driver may select the frequency function 184 by touching an icon on the touch screen. The driver may then set the repetition rate at which the animated avatar 150 is presented on the audio head unit display 130 to any period of time, e.g. hourly or any type of event, e.g. service notices. The updated frequency function 184 is then stored in memory as a component of the one or more alterable functional characteristics 180. The one or more alterable visual characteristics 152 may also be altered in a similar fashion. It is noted that embodiments of the animated vehicle attendant system 100, 200, and 300 may comprise any number of interfaces that provide an interconnection with the animated avatar. Furthermore, the interfaces may be positioned throughout the passenger compartment, and may operate independently or simultaneously. While the above examples describe selecting from menus depicted on the audio head unit display 130, it is noted that in other embodiments the menus and/or submenus may be depicted on the instrument cluster display 140, the climate display 160, or any combination thereof. Similarly, while the animated avatar 150 is described as being stored in the audio memory 134 (FIG. 3), in further embodiments, the animated avatar 150 may be stored in the cluster memory 144, climate memory 164, or any combination thereof.

Referring again to FIGS. 1 and 3, the animated avatar 150 may be created based solely on user input or customized from a default setting. In one embodiment, the animated avatar 150 is initially defined by the driver via the avatar creation interface 110, as described above. In another embodiment of the vehicle attendant system 100 the one or more alterable visual characteristics 152 of the animated avatar 150 may be selected and stored in the audio memory 134 prior to delivery of the vehicle 120 to the driver. For instance, a driver of a certain type of vehicle such as, for example, a station wagon, a mini van, a sports car, a truck and the like, may be predisposed towards a specific set of the one or more alterable visual characteristics 152. For example, if the vehicle 120 is a truck, the driver may be more likely to associate with a construction worker. Thus, the audio processor 132 executes machine readable instructions to present the construction worker as a default animated avatar 150 on the audio head unit display 130. Furthermore, a manufacturer may have a set of animated avatars 150 preloaded for certain types of vehicles based on data collected during marketing studies or sales campaigns.

Referring again to FIGS. 1 and 3, embodiments of the animated vehicle attendant system 100 utilize multiple displays to present the animated avatar 150 in order to communicate information to the driver. In one embodiment, the audio processor 132 and the cluster processor 142 execute the machine readable instructions to present a coordinated sequence of images of the animated avatar 150. At least a portion of the coordinated sequence of images is presented on the audio head unit display 130 and the instrument cluster display 140. For example, the vehicle may be equipped with a global positioning system that provides turn by turn directions. The animated avatar 150 first appears on the audio head unit display 130 and requests the driver to select a destination. Once, the destination has been selected the animated avatar 150 walks in an animated motion off of the audio head unit display 130 and reappears on the instrument cluster display 140 to give turn by turn directions. In further embodiments, the avatar may be presented simultaneously on any combination of the audio head unit display 130, the instrument cluster display 140 and the climate display 160. It is noted that, in the present embodiment or any other embodiment disclosed herein, any combination of the audio processor 132, the cluster processor 142, and the climate processor 162, or any other processor within the vehicle, may be used to execute machine readable instructions to present a coordinated sequence of animated avatar 150 images when the processors are communicatively coupled to the communication path 12.

Referring again to FIG. 3, embodiments of the present disclosure comprise a vehicle-machine communication device 114 that provides a two-way exchange of data between the vehicle 120 and any other device, as described above. In one embodiment, the vehicle-machine communication device 114 is communicatively coupled to the communication path 112. A remote memory 170 is communicatively coupled to the vehicle-machine communication device 114 to facilitate the exchange of information between the vehicle-machine communication device 114 and the remote memory 170. For example, in one embodiment the audio processor 132 executes machine readable instructions to update the animated avatar 150 with information from the remote memory 170. Input related to the one or more alterable visual characteristics 152 is received by the vehicle-machine communication device 114 from the remote memory 170. The audio processor 132 updates the one or more alterable visual characteristics 152 of the animated avatar 150 based on the input from the remote memory 170 and stores the updated one or more alterable visual characteristics 152 in memory. In another embodiment, a unique, customized animated avatar 150 may be downloadable to the vehicle 120 and stored in memory via the vehicle-machine communication device 114.

In another embodiment, the remote memory 170 is communicatively coupled to a vehicle attendant portal 172 to provide a more advanced feature set to customize the animated avatar 150. For example, the number of options provided within each of the one or more alterable visual characteristics 152 presented on the audio head unit display 130 may be limited to about ten or less. However, the vehicle attendant portal 172 can be accessed from a home computer and can provide an extended feature set of alterable characteristics. Additionally, the vehicle attendant portal 172 can collect upgrades, videos, ad campaigns, or any other information to extend the customizable features provided within the vehicle 120. For example, a software upgrade may be loaded onto the remote memory 170 from the vehicle attendant portal 172. The audio processor 132 may receive the software upgrade as input from the remote memory 170 via the vehicle-machine communication device 114 and the communication path 112.

Still referring to FIG. 3, further embodiments of the animated vehicle attendant system 100 comprise an environmental sensor 166 to provide information about ambient conditions outside of the vehicle 120, as described above. In one embodiment, the environmental sensor 166 is coupled to the vehicle 120 and communicatively coupled to the communication path 112. The environmental sensor 166 comprises an environmental memory 168 for storing environmental information. The environmental sensor 166 may be configured to sense ambient temperature. On a cold day, for example, the environmental sensor 166 senses a cold temperature and stores information indicative of the cold temperature in the environmental memory 168. The audio processor 132 executes machine readable instructions to receive the environmental information from the environmental memory 168 via the communication path 112, and update the one or more alterable visual characteristics 152 based upon a customization feature that corresponds to the cold temperature. In one embodiment, the audio processor 132 modifies the animated avatar 150 with a cold customization feature. The modified animated avatar 150 is presented on the audio head unit display 130 with the cold customization feature, for example a winter coat. In further embodiments, a customization feature may correspond to any ambient condition sensed by the environmental sensor 166, as described herein. For example, the customization feature may be a fan for a hot temperature, an umbrella for rain, sunglasses for sunny conditions, and the like. Still further embodiments combine multiple customization features, such as, for example, a hot temperature and sunny conditions.

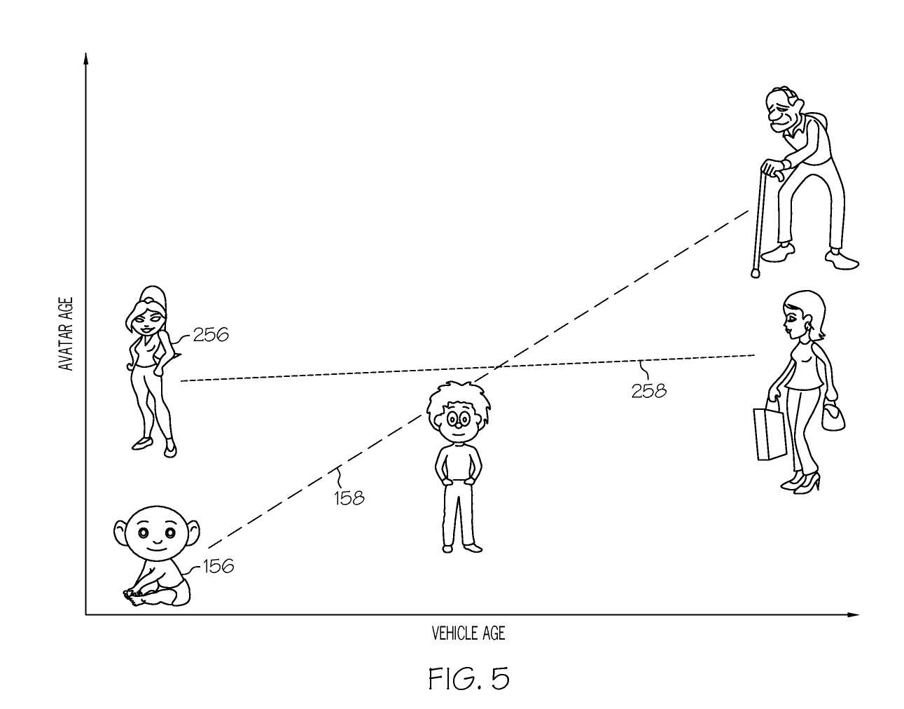

In further embodiments, as schematically depicted in FIG. 5, the animated avatar 150 comprises a customizable avatar age that changes as the vehicle ages. In one embodiment, the one or more alterable visual characteristics 152 comprises a customizable avatar age based on an initial age 156 and an aging rate 158 each of which can be customized to allow a driver to further personalize the animated avatar 150. The avatar age is an initial age 156 plus the age of the vehicle multiplied by the aging rate 158. For example, the initial age corresponds to the vehicle age when the vehicle 120 is first delivered to the driver. The initial age 156 can be set to an infant and the animated avatar 150 initially appears to be an infant. The aging rate 158 can be scaled by the driver such that in the middle of the driver's ownership period the avatar age is that of a young adult and at the end of the period, the avatar age is that of a senior citizen. Thus, when the animated avatar 150 is presented during the middle of the driver's ownership period the animated avatar 150 visually appears to be a young adult. Similarly, when the animated avatar 150 is presented during the end of the driver's ownership period the animated avatar 150 visually appears to be a senior citizen. The visual appearance may be based on features that mimic aging indicia observed in humans such as, but not limited to, stature, posture, or facial expressions. In another example, initial age 256 can be set to a teenager and the aging rate 258 can be scaled such that at the end of the driver's ownership period the avatar is a young adult. Therefore, the animated avatar 150 can age with the vehicle 120 based upon an aging rate 158 customized by the driver. The vehicle age may be based upon a mileage, a date of manufacture, a date of lease, or any other measure of the vehicle that corresponds to time. Furthermore, the aging rate 158 may be scaled differently depending on which vehicle age quantity the driver chooses as the basis for the avatar age. For example, the aging rate 158 may be higher when correlated to mileage than the aging rate 258 correlated to a lease period. While the avatar age is described above as being variable, it is noted that the avatar age may be fixed at any value.

It should now be understood that the embodiments described herein relate to animated vehicle attendant systems. An animated avatar graphically communicates necessary or desired information to the driver with some form of personality. The personality based on appearance and function works to develop a closer link, or a pseudo-relationship, between a driver and the vehicle. Additionally, the animated avatar ages and evolves over time to reinforce the pseudo-relationship. Thus, the driver develops a trust and kinship with the avatar as it serves as the central link to access various vehicle systems.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An animated vehicle attendant system comprising:
a communication path positioned within a vehicle;
an avatar creation interface positioned within a passenger compartment of the vehicle and communicatively coupled to the communication path;
a first display positioned within the passenger compartment of the vehicle and communicatively coupled to the communication path, wherein the first display comprises a first processor and a first memory;
a second display positioned within the passenger compartment of the vehicle and communicatively coupled to the communication path, wherein the second display comprises a second processor and a second memory; and
an animated avatar comprising one or more alterable visual characteristics, wherein the animated avatar is stored in the first memory and/or the second memory and the first processor and/or the second processor executes machine readable instructions to:
receive input from the avatar creation interface;
update the one or more alterable visual characteristics based upon the input from the avatar creation interface; and
present the animated avatar on the first display and/or the second display.

2. The animated vehicle attendant system of claim 1 wherein the first processor and/or the second processor executes the machine readable instructions to present a coordinated sequence of images of the animated avatar transitioning between the first display and the second display, such that at least a portion of the coordinated sequence of images is presented on the first display and the second display.

3. The animated vehicle attendant system of claim 1 wherein the animated avatar is presented simultaneously on the first display and the second display.

4. The animated vehicle attendant system of claim 1 further comprising a third display positioned within the passenger compartment of the vehicle and communicatively coupled to the communication path, wherein:
the third display comprises a third processor and a third memory;
the animated avatar is stored in the third memory and the third processor executes the machine readable instructions to:
receive input from the avatar creation interface;
update the one or more alterable visual characteristics based on the input from the avatar creation interface; and
present the animated avatar on the third display.

5. The animated vehicle attendant system of claim 1 further comprising a vehicle-machine communication device communicatively coupled to the communication path and a remote memory communicatively coupled to the vehicle-machine communication device, wherein the first processor and/or the second processor executes the machine readable instructions to:
receive input from the remote memory; and
update the one or more alterable visual characteristics based on the input from the remote memory.

6. The animated vehicle attendant system of claim 5 wherein the remote memory is a portable storage device.

7. The animated vehicle attendant system of claim 5 wherein the remote memory is an internet device.

8. The animated vehicle attendant system of claim 7 further comprising a vehicle attendant portal communicatively coupled to the remote memory, wherein the vehicle attendant portal modifies the input from the remote memory.

9. The animated vehicle attendant system of claim 1 wherein the one or more alterable visual characteristics comprises an avatar age, an initial age and an aging rate, and the first processor and/or the second processor executes the machine readable instructions to:
update at least one of the avatar age, the initial age and the aging rate based upon the input from the avatar creation interface.

10. The animated vehicle attendant system of claim 9 wherein the avatar age is based upon a mileage, a date of manufacture or a lease date.

11. The animated vehicle attendant system of claim 1 wherein the one or more alterable visual characteristics are preset based upon a type of the vehicle.

12. The animated vehicle attendant system of claim 1 wherein the avatar creation interface is a touch screen, a steering wheel control or a console control.

13. An animated vehicle attendant system comprising:
a communication path positioned within a vehicle;
an environmental sensor coupled to the vehicle and communicatively coupled to the communication path, wherein the environmental sensor comprises an environmental memory for storing environmental information;
a display positioned within a passenger compartment of the vehicle and communicatively coupled to the communication path, wherein the display comprises a processor and a memory;
an avatar creation interface positioned within the passenger compartment of the vehicle and communicatively coupled to the communication path; and
an animated avatar comprising one or more alterable visual characteristics, wherein the animated avatar is stored in the memory and the processor executes machine readable instructions to:
receive the environmental information from the environmental memory;
receive input from the avatar creation interface;
update the one or more alterable visual characteristics based upon the environmental information;
update the one or more alterable visual characteristics of the animated avatar based upon the input from the avatar creation interface; and
present an updated animated avatar on the display.

14. The animated vehicle attendant system of claim 13 wherein the one or more alterable visual characteristics comprises an avatar age, an initial age and an aging rate, wherein the avatar age is equal to the initial age plus the aging rate multiplied by a vehicle age.

15. The animated vehicle attendant system of claim 13 wherein the environmental information is indicative of light, temperature, barometric pressure, altitude, humidity, or precipitation.

16. The animated vehicle attendant system of claim 13 wherein the animated avatar comprises one or more alterable functional characteristics and the processor executes the machine readable instructions to update the one or more alterable functional characteristics based upon the input from the avatar creation interface.

17. The animated vehicle attendant system of claim 16 wherein the one or more alterable functional characteristics is a calendar function, a frequency function, or a combination thereof.

18. The animated vehicle attendant system of claim 13 wherein the avatar creation interface is a touch screen, a steering wheel control or a console control.

19. An animated vehicle attendant system comprising:
a communication path positioned within a vehicle;
an avatar creation interface positioned within a passenger compartment of the vehicle and communicatively coupled to the communication path;
a display positioned within the passenger compartment of the vehicle and communicatively coupled to the communication path, wherein the display comprises a processor and a memory; and
an animated avatar comprising an aging rate, wherein the animated avatar is stored in the memory and the processor executes machine readable instructions to:
receive input from the avatar creation interface;
update the aging rate based upon the input from the avatar creation interface; and
present the animated avatar on the display.

20. The animated vehicle attendant system of claim 19 further comprising a second display communicatively coupled to the communication path, wherein:
the second display comprises a second processor and a second memory; and
the processor and/or the second processor executes the machine readable instructions to present a coordinated sequence of images of the animated avatar such that at least a portion of the coordinated sequence of images is presented on the display and the second display.
